(19) United States
(12) Patent Application Publication
(10) Pub. No.: US 2024/0280746 A1
(43) Pub. Date: Aug. 22, 2024

(54) OPTICAL FIBER

(71) Applicant: FURUKAWA ELECTRIC CO., LTD., Tokyo (JP)

(72) Inventors: Shugo TAKEUCHI, Tokyo (JP); Keiichi AISO, Tokyo (JP); Kazunori MUKASA, Tokyo (JP); Yoshihiro ARASHITANI, Tokyo (JP)

(73) Assignee: FURUKAWA ELECTRIC CO., LTD., Tokyo (JP)

(21) Appl. No.: 18/650,311

(22) Filed: Apr. 30, 2024

Related U.S. Application Data
(63) Continuation of application No. PCT/JP2022/040547, filed on Oct. 28, 2022.

(30) Foreign Application Priority Data
Nov. 10, 2021 (JP) 2021-183517

(51) Int. Cl. G02B 6/036

(52) U.S. Cl. CPC G02B 6/03694; G02B 6/03627

(57) ABSTRACT

An optical fiber includes: a core portion; and a cladding portion that has a refractive index lower than a maximum refractive index of the core portion and that surrounds an outer periphery of the core portion. The core portion includes a center core doped with germanium, and a low refractive index layer that surrounds an outer periphery of the center core, and in which −Δmax that is a minimum value of a relative refractive-index difference with respect to an average refractive index of the cladding portion is a negative value. A residual compressive stress in the center core is equal to or larger than 40 MPa and equal to or less than 150 MPa, and Δ1 that is an average maximum relative refractive-index difference of the center core with respect to the average refractive index of the cladding portion is equal to or less than 0.8%.

This application is a continuation of International Application No. PCT/JP2022/040547, filed on Oct. 28, 2022 which claims the benefit of priority of the prior Japanese Patent Application No. 2021-183517, filed on Nov. 10, 2021, the entire contents of which are incorporated herein by reference.

### BACKGROUND

The present disclosure relates to an optical fiber.

An optical fiber with a low bending loss capable of stable communication in various environments is attracting increasing attention toward the realization of next-generation communication infrastructure. Control of a refractive index profile is one of major efforts to implement a low bending loss. For example, in a case of a trench type profile, it is possible to easily reduce a bending loss by providing a trench layer in a clad region, and it is also possible to implement a favorable property regarding another property, such as a mode field diameter (MFD).

On the other hand, in order to improve the property, such as a rupture property, in an optical fiber, an optical fiber having a residual stress has been disclosed (see Japanese Laid-open Patent Publication No. 2007-297254, Japanese Patent No. 4663277, Japanese Laid-open Patent Publication No. 2003-207675, Japanese Patent No. 5831189 and Japanese Patent No. 6020045).

### SUMMARY

Regarding a control technique of the refractive index profile, control using dopants has been the main method. For example, in a case where a refractive index of a core portion is increased in order to reduce a bending loss, a method of increasing a relative refractive-index difference of the core portion with respect to a cladding portion has been used by decreasing a refractive index of a cladding portion or by increasing an amount of a dopant in a core portion. Accordingly, there are concerns of degradation of a transmission loss caused by an increase in Rayleigh scattering in accordance with an addition of a dopant, an establishment of a technique of adding a dopant, and the like.

On the other hand, sufficient studies have not been conducted on a relationship between a residual stress in an optical fiber and a property of an optical fiber, in particular, a relationship with a property of a bending resistance of an optical fiber.

There is a need for an optical fiber having a low bending loss while an increase in a transmission loss being suppressed.

According to one aspect of the present disclosure, there is provided an optical fiber including: a core portion; and a cladding portion that has a refractive index lower than a maximum refractive index of the core portion and that surrounds an outer periphery of the core portion, wherein the core portion includes a center core doped with germanium, and a low refractive index layer that surrounds an outer periphery of the center core, and in which −Δmax that is a minimum value of a relative refractive-index difference with respect to an average refractive index of the cladding portion is a negative value, a residual compressive stress in the center core is equal to or larger than 40 MPa and equal to or less than 150 MPa, and Δ1 that is an average maximum relative refractive-index difference of the center core with respect to the average refractive index of the cladding portion is equal to or less than 0.8%.

### BRIEF DESCRIPTION OF DRAWINGS

FIG. 1 is a schematic cross-sectional view of a surface that is perpendicular to a longitudinal direction of an optical fiber according to a first embodiment;

FIG. 2 is a schematic view of a refractive index profile and a corresponding residual stress of the optical fiber according to the first embodiment;

FIG. 3 is a schematic view of a refractive index profile of an optical fiber according to a second embodiment; and

FIG. 4 is a schematic view of a refractive index profile of an optical fiber according to a comparative example.

### DESCRIPTION OF EMBODIMENTS

Embodiments will be described in detail below with reference to the drawings. The present disclosure is not limited by the embodiments described below. Furthermore, in each of the drawings, the same or corresponding component elements are appropriately denoted by the same reference symbols. In addition, in the present specification, a cutoff wavelength or an effective cutoff wavelength indicates a cable cutoff wavelength (λcc) that is defined by ITU-T G.650.1 of the International Telecommunication Union (ITU). Moreover, other terms that are not specifically defined in the present specification conform to definitions and measurement methods described in G.650.1 and G.650.2.

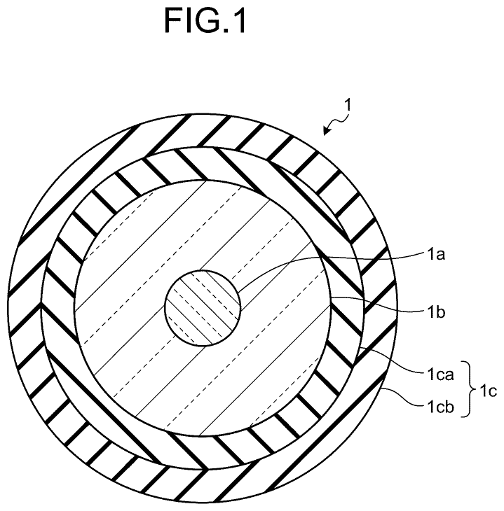

FIG. 1 is a schematic cross-sectional view of a surface that is perpendicular to a longitudinal direction of an optical fiber according to a first embodiment. An optical fiber 1 is made of silica based glass, and includes a core portion 1a, and a cladding portion 1b that surrounds an outer periphery of the core portion 1a and in which the refractive index is lower than the maximum refractive index of the core portion 1a. Furthermore, the portion that includes the core portion 1a and the cladding portion 1b included in the optical fiber 1 is a portion made of glass in the optical fiber, and is sometimes referred to as a glass optical fiber. Moreover, the optical fiber 1 includes a coating portion 1c that surrounds an outer periphery of the cladding portion 1b. The coating portion 1c includes a primary layer 1ca that surrounds the outer periphery of the cladding portion 1b and a secondary layer 1cb that surrounds an outer periphery of the primary layer 1ca. The optical fiber that is provided with the coating portion 1c may referred to as an optical fiber core wire.

An outer diameter of the cladding portion 1b (cladding diameter) is not particularly limited, but is preferably within the range of 125 μm±10 μm. Furthermore, in terms of a reduction in the diameter of the optical fiber 1, the cladding diameter may also be within the range of 115 μm±10 μm, may also be within the range of 105 μm±10 μm, may also be within the range of 95 μm±10 μm, or may also be within the range of 85 μm±10 μm.

The outer diameter of the secondary layer 1cb is, for example, equal to or less than 260 μm, but may have a smaller diameter in accordance with a reduction in the diameter of the cladding diameter. Furthermore, the primary layer 1ca is made of resin in which, for example, Young's modulus is equal to or larger than 0.2 MPa and equal to or less than 3 MPa. Moreover, the secondary layer 1cb is made of resin in which, for example, Young's modulus is equal to or larger than 5 MPa and equal to or less than 2000 MPa.

The resin that constitutes the primary layer 1ca and the resin that constitutes the secondary layer 1cb are, for example, an ultraviolet-curing resin. The ultraviolet-curing resin is a mixture of, for example, various kinds of resin materials, such as an oligomer, a diluent monomer, a photopolymerization initiator, a silane coupling agent, a sensitizing agent, a lubricant agent, and an addition agent. An example of the oligomer used includes a known material, such as Polyether urethane acrylate, epoxy acrylate, polyester acrylate, or silicone acrylate. An example of a diluent monomer used includes a known material, such as a monofunctional monomer or a polyfunctional monomer. Furthermore, the addition agent is not limited to the above described agents, it may be possible to widely use known addition agents or the like that are used for the ultraviolet-curing resin or the like.

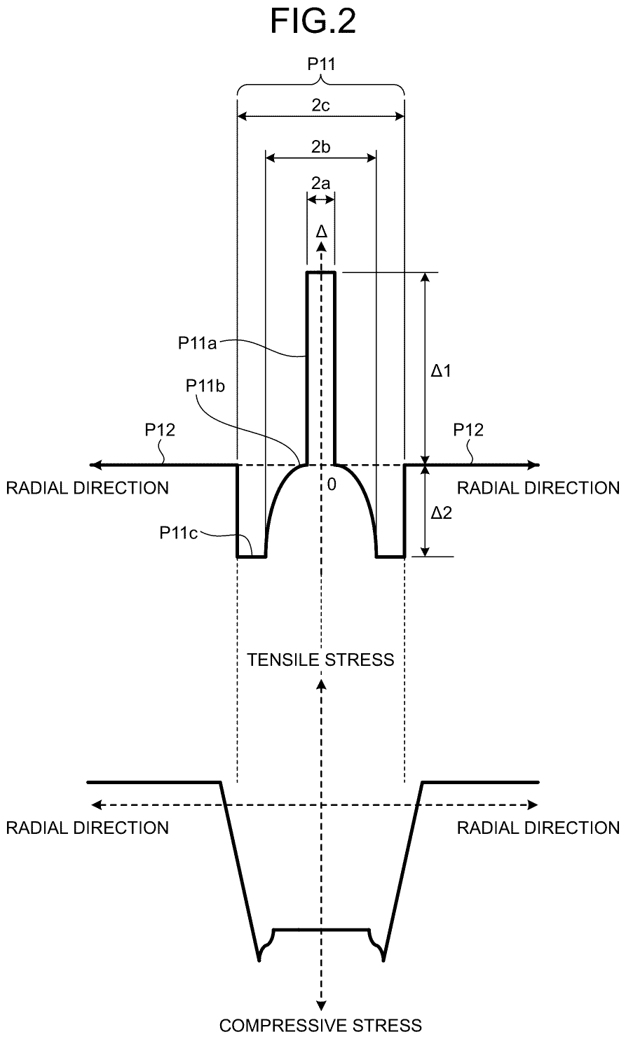

FIG. 2 is a schematic view of a refractive index profile of the optical fiber and a corresponding residual stress of the optical fiber according to the first embodiment. The refractive index profile illustrated in FIG. 2 is what is called a trench-type refractive index profile, and represents a relative refractive-index difference. In FIG. 2, a profile P11 indicates a refractive index profile of the core portion 1a, and a profile P12 indicates a refractive index profile of the cladding portion 1b. In the trench-type refractive index profile, the core portion 1a is constituted by a center core that has a diameter of 2a, an intermediate layer that is formed so as to surround the outer periphery of the center core, that has a refractive index that is smaller than the maximum refractive index of the center core, that has an inner diameter of 2a, and that has an outer diameter of 2b, and a trench layer that is formed so as to surround an outer periphery of the intermediate layer, that has a refractive index that is smaller than a refractive index of the cladding portion, that has an inner diameter of 2b, and that has an outer diameter of 2c. The profile P11a denotes a refractive index profile of the center core, the profile P11b denotes a refractive index profile of the intermediate layer, and the profile P11c is a refractive index profile of the trench layer.

The center core is a portion in which the average refractive index is the maximum in the core portion 1a. The average maximum relative refractive-index difference of the center core with respect to the average refractive index of the cladding portion 1b is Δ1. The trench layer is one example of a low refractive index layer and is a layer that surrounds the outer periphery of the center core and in which −Δmax that is the minimum value of a relative refractive-index difference with respect to the average refractive index of the cladding portion 1b is a negative value. Furthermore, in FIG. 2, −Δmax is denoted by Δ2. The trench layer is separated from the center core because the intermediate layer is present between the trench layer and the center core.

In the intermediate layer, the relative refractive-index difference is continuously changed from the inner side to the outer side in the radial direction. As a result of this, in the optical fiber 1, the relative refractive-index difference is continuously changed from the center core to the trench layer in the radial direction. Here, the relative refractive-index difference being continuously changed implies that the refractive index profile representing the relative refractive-index difference is not sharply bent but is smoothly changed, and implies that an amount of change in the relative refractive-index difference is equal to or less than 0.1% per 1 μm in the radial direction. In contrast, a boundary between the intermediate layer and the trench layer may be defined by an amount of change in the relative refractive-index difference. For example, when the amount of change in the relative refractive-index difference is viewed from the center side, if a portion in which the amount of change in the relative refractive-index difference is equal to or less than 0.1% per 1 μm in the radial direction, it may be said that the portion is the intermediate layer, and if a portion in which the amount of change in the relative refractive-index difference exceeds 0.1%, it may be said that the portion moves to the trench layer across the boundary.

Furthermore, in addition to the shape of the step-type refractive index profile that is a geometrically ideal shape, the refractive index profile of the center core of the core portion 1a has sometimes an uneven shape due to a manufacturing property instead of a flat shape at the top portion, or has a shape having a tail from the top portion. In this case, the refractive index in a substantially flat area at the top portion of the refractive index profile within a range of a core diameter 2a (the diameter of the center core) of the core portion 1a from the viewpoint of the manufacturing design serves as an indicator for determining Δ1. Furthermore, it has been confirmed that, even in the case where substantially flat areas are assumed to be present in a plurality of portions, or even in also the case where it is difficult to define a substantially flat area due to a continuous change, it is possible to exhibit an almost desired property as long as at least one of the core portions other than the portion in which the refractive index is sharply changed toward the adjacent layer is within the range of Δ1 described below and the difference of A between the maximum value and the minimum value is within ±30% of a certain value, and there is no particular problem.

In the following, constitutional materials of the core portion 1a and the cladding portion 1b of the optical fiber 1 will be described. The center core of the core portion 1a is made of silica glass doped with germanium (Ge). Ge is dopant that increases the refractive index of the silica glass. Furthermore, the trench layer is made of silica glass such that at least a part of the trench layer includes a dopant, such as fluorine (F) or boron (B), that decreases the refractive index. The intermediate layer is made of silica glass having the same component as that of the cladding portion 1b or a component similar to the component of the cladding portion 1b.

The cladding portion 1b is made of, for example, pure silica glass. The pure silica glass mentioned here is extremely high purity silica glass that does not practically contain a dopant that changes the refractive index and that has the refractive index of about 1.444 at the wavelength of 1550 nm. However, a dopant may be added to the cladding portion 1b.

Here, as also illustrated in FIG. 2, in the optical fiber 1, the core portion 1a has a residual compressive stress, and, in particular, the residual compressive stress in the center core is equal to or larger than 40 MPa and equal to or less than 150 MPa. In this way, as a result of a large residual compressive stress being present in the center core, a photoelastic effect is exerted in the center core, and, in addition to rising effect of the refractive index due to the dopant, such as Ge, that increases the refractive index, the refractive index is increased due to the photoelastic effect. Therefore, it is possible to reduce an amount of a dopant to be added in order to implement the same Δ1. As a result of this, it is possible to relatively reduce an occurrence of Rayleigh scattering caused by the dopant, so that it is possible to reduce a transmission loss. Furthermore, it is possible to implement a low bending loss property by increasing Δ1 by the photoelastic effect.

The effect of an increase in the refractive index due to the photoelastic effect is sufficient as long as the residual compressive stress in the center core is equal to or larger than 40 MPa, and, practically, it is preferable that the residual compressive stress be equal to or less than 150 MPa. In the case where the residual compressive stress is larger than 150 MPa, the temperature at the time of drawing of an optical fiber process that will be described later is low, and there may be a case in which a transmission loss is degraded due to generation of a structural defect of glass.

Furthermore, in the optical fiber 1, the cladding portion 1b has a residual tensile stress. As a result of this, a difference of the residual stress between the core portion 1a and the cladding portion 1b becomes large, so that the relative refractive-index difference also becomes large, which is preferable in terms of implementation of a low bending loss while an increase in the transmission loss being suppressed.

Therefore, the optical fiber 1 according to the first embodiment has a property of a low bending loss while an increase in the transmission loss being suppressed.

Furthermore, if Δ1 of the center core is equal to or less than 0.8%, it is possible to reduce the dopant, such as Ge, which is preferable in terms of suppression of an increase in the transmission loss. In addition, if Δ1 of the center core is equal to or less than 0.8%, it is also preferable in terms of suppression of an occurrence of foaming at the time of manufacturing.

Moreover, it is preferable that Δ1 of the center core be larger than 0.25%. The reason for this is that, if Δ1 of the center core is equal to or less than 0.25%, the effect of confinement of light becomes weak, and thus, degradation of the bending loss, a transition of a zero dispersion wavelength to a short wavelength, or the like may possibly occur.

Moreover, if −Δmax (Δ2) of the trench layer is equal to or larger than −0.5% and equal to or less than −0.1%, this state is preferable in terms of implementation of a low bending loss.

Moreover, in the core portion 1a included in the optical fiber 1, it is preferable that the core diameter 2a that is the diameter of the center core (see FIG. 2) be equal to or larger than 3 μm and equal to or less than 8 μm, and it is preferable that the outer diameter 2c of the trench layer (see FIG. 2) be equal to or larger than 9 μm and equal to or less than 20 μm. Moreover, it is preferable that the core diameter 2a be equal to or larger than 3.5 μm and equal to or less than 7.5 μm, and it is preferable that the outer diameter 2c of the trench layer be equal to or larger than 9.5 μm and equal to or less than 19 μm. In particular, it is more preferable that the core diameter 2a be equal to or larger than 3.5 μm and equal to or less than 5 μm, and it is preferable that the outer diameter 2c of the trench layer be equal to or larger than 12 μm and equal to or less than 16 μm.

The core diameter 2a is preferably be within the above described range in that it is possible to obtain the properties of the optical fiber 1 including a low bending loss, a mode field diameter, a cutoff wavelength, a zero dispersion wavelength, and the like in a well-balanced manner. For example, it is possible to obtain the favorable properties of the optical fiber 1 in which the transmission loss at the wavelength of 1550 nm is equal to or less than 0.190 dB/km, the mode field diameter at the wavelength of 1310 nm is equal to or larger than 8.6 μm, the cable cutoff wavelength is equal to or less than 1260 nm, and the zero dispersion wavelength is equal to or larger than 1300 nm in a well-balanced manner. In particular, control of the outer diameter 2c of the trench layer is effective in terms of a reduction in the bending loss.

Furthermore, if the maximum value of the difference of the residual stress between the core portion 1a and the cladding portion 1b is equal to or larger than 40 MPa and equal to or less than 220 MPa, this state is preferable in terms of implementation of a low bending loss while an increase in the transmission loss being suppressed, and it is more preferable if the maximum value of the difference thereof is equal to or larger than 70 MPa.

Furthermore, if the residual compressive stress in the trench layer is equal to or larger than 20 MPa and equal to or less than 200 MPa, it is possible to obtain the effect of a low transmission loss due to structural relaxation of the core portion 1a as a result of a soft trench layer. Moreover, it is possible to allow the entire of the core portion 1a to be a compressed atmosphere, and, as a result, it is possible to obtain the effect in that the refractive index is likely to be increased due to the photoelastic effect.

The optical fiber 1 having the residual stress indicated in FIG. 2 may be implemented by appropriately adjusting a linear velocity, a tension, and a temperature at the time of drawing of the optical fiber 1 performed from an optical fiber preform that has been manufactured by using various kinds of methods, such as a Vapor-phase Axial Deposition (VAD) method, of manufacturing a preform.

In the following, an optical fiber according to a second embodiment will be described. The optical fiber according to the second embodiment is different from the optical fiber according to the first embodiment in that the refractive index profile is what is called a W type. Accordingly, in the following, the refractive index profile of the optical fiber according to the second embodiment will be described, and other descriptions thereof will appropriately be omitted.

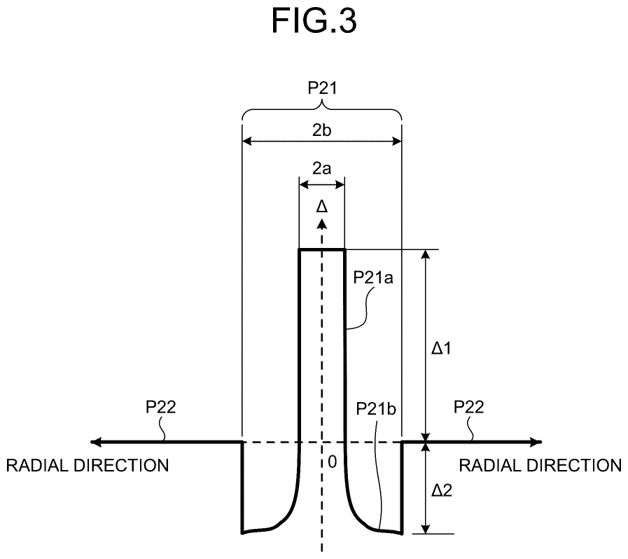

FIG. 3 is a schematic view of the refractive index profile of the optical fiber according to the second embodiment. The refractive index profile illustrated in FIG. 3 is a W-type refractive index profile and represents a relative refractive-index difference. In FIG. 3, a profile P21 indicates the refractive index profile of the core portion, and a profile P22 indicates the refractive index profile of the cladding portion. In the W-type refractive index profile, the core portion is constituted by a center core that has the diameter of 2a and a depressed layer that is formed so as to surround the outer periphery of the center core, that has the refractive index that is smaller than the refractive index of the cladding portion, that has an inner diameter of 2a, and that has an outer diameter of 2b. A profile P21a denotes the refractive index profile of the center core, and a profile P21b denotes the refractive index profile of the depressed layer.

The center core is a portion in which the average refractive index is the maximum in the core portion. The average maximum relative refractive-index difference of the center core with respect to the average refractive index of the cladding portion is Δ1. The depressed layer is one example of the low refractive index layer and is a layer that surrounds the outer periphery of the center core and in which −Δmax that is the minimum value of the relative refractive-index difference with respect to the average refractive index of the cladding portion is a negative value. Furthermore, in FIG. 3, −Δmax is denoted by Δ2. The depressed layer is adjacent to the center core.

In the depressed layer, the relative refractive-index difference is continuously changed from the inner side to the outer side in the radial direction. As a result of this, in the optical fiber according to the second embodiment, the relative refractive-index difference is continuously changed from the center core to the depressed layer in the radial direction. Here, the relative refractive-index difference being continuously changed implies that the refractive index profile representing the relative refractive-index difference is not sharply bent but is smoothly changed, and implies that an amount of change in the relative refractive-index difference is equal to or less than 0.1% per 1 μm in the radial direction.

In also the optical fiber according to the second embodiment, the core portion has a residual compressive stress, and, in particular, the residual compressive stress in the center core is equal to or larger than 40 MPa and equal to or less than 150 MPa. In this way, as a result of a large residual compressive stress being present in the center core, similar to the case in the first embodiment, it is possible to reduce an amount of dopant to be added in order to implement the same Δ1, so that it is possible to reduce a transmission loss. Furthermore, it is possible to implement a low bending loss property by increasing Δ1 by the photoelastic effect.

In addition, in also the optical fiber according to the second embodiment, the cladding portion has a residual tensile stress. As a result of this, similar to the case in the first embodiment, this state is preferable in terms of implementation of a low bending loss while an increase in the transmission loss being suppressed.

Therefore, the optical fiber according to the second embodiment has a property of exhibiting a low bending loss while an increase in the transmission loss being suppressed.

Moreover, if Δ1 of the center core is equal to or less than 0.8%, this state is preferable in terms of suppression of an increase in the transmission loss and an occurrence of foaming at the time of manufacturing. In addition, it is preferable that Δ1 of the center core be larger than 0.25%. The reason for this is that, if Δ1 of the center core is equal to or less than 0.25%, the effect of confinement of light becomes weak, and thus, degradation of the bending loss, a transition of a zero dispersion wavelength to a short wavelength, or the like may possibly occur.

Moreover, if −Δmax (Δ2) of the depressed layer is equal to or larger than −0.5% and equal to or less than −0.1%, this state is preferable in terms of implementation of the low bending loss.

Moreover, in the core portion included in the optical fiber according to the second embodiment, it is preferable that the core diameter 2a that is the diameter of the center core (see FIG. 3) be equal to or larger than 3 μm and equal to or less than 8 μm, and it is preferable that an outer diameter 2b of the depressed layer (see FIG. 3) be equal to or larger than 9 μm and equal to or less than 20 μm. Moreover, it is more preferable that the core diameter 2a be equal to or larger than 3.5 μm and equal to or less than 7.5 μm, and it is more preferable that the outer diameter 2b of the depressed layer be equal to or larger than 9.5 μm and equal to or less than 19 μm. In particular, it is more preferable that the core diameter 2a be equal to or larger than 3.5 μm and equal to or less than 5 μm, and it is more preferable that the outer diameter 2b of the depressed layer be equal to or larger than 12 μm and equal to or less than 16 μm.

The core diameter 2a is preferably be within the above described range in that it is possible to obtain the properties of the optical fiber according to the second embodiment including a low bending loss, a mode field diameter, a cutoff wavelength, a zero dispersion wavelength, and the like in a well-balanced manner. For example, it is possible to obtain the favorable properties of optical fiber according to the second embodiment in which the transmission loss at the wavelength of 1550 nm is equal to or less than 0.190 dB/km, the mode field diameter at the wavelength of 1310 nm is equal to or larger than 8.6 μm, the cable cutoff wavelength is equal to or less than 1260 nm, and the zero dispersion wavelength is equal to or larger than 1300 nm in a well-balanced manner. In particular, control of the outer diameter 2b of the depressed layer is effective in terms of a reduction in the bending loss.

Furthermore, if the maximum value of the difference of the residual stress between the core portion and the cladding portion is equal to or larger than 40 MPa and equal to or less than 220 MPa, this state is preferable in terms of implementation of a low bending loss while an increase in the transmission loss being suppressed, it is more preferable if the maximum value of the difference thereof is equal to or larger than 70 MPa.

Furthermore, if the residual compressive stress in the depressed layer is equal to or larger than 20 MPa and equal to or less than 200 MPa, this state is preferable in terms of implementation of a low bending loss.

Furthermore, in the optical fiber according to the first and the second embodiments, if the transmission loss at the wavelength of 1550 nm is equal to or less than 0.190 dB/km, this state exhibits a low transmission loss, which is preferable.

Furthermore, if the mode field diameter at the wavelength of 1310 nm is equal to or larger than 8.6 μm, the cable cutoff wavelength is equal to or less than 1260 nm, and the zero dispersion wavelength is equal to or larger than 1300 nm, the optical fiber satisfies at least a part of the standard defined by ITU-T G652.D.

Furthermore, if the macrobending loss at the wavelength of 1550 nm when the optical fiber is wound with a diameter of 20 mm is equal to or less than 0.1 dB/turn, this state indicates a low bending loss, and the optical fiber satisfies at least a part of the standard defined by ITU-T G657.Δ2.

As Examples, optical fibers having the refractive index profile illustrated in FIG. 2 according to Examples 1 to 6 have been manufactured. When each of the optical fibers according to Examples 1 to 6 is manufactured, the residual stress has been adjusted by appropriately adjusting a linear velocity, a tension, and a temperature at the time of a drawing process.

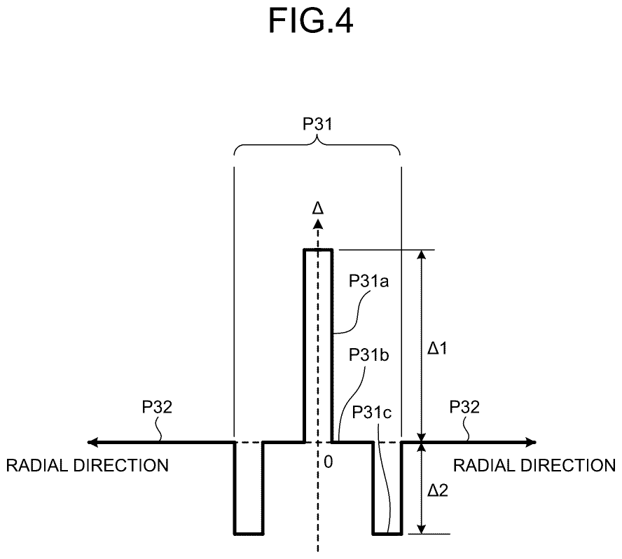

On the other hand, as a comparative example, an optical fiber having the refractive index profile illustrated in FIG. 4 has been manufactured. At the time of manufacturing the optical fiber according to the comparative example, adjustment has been performed such that the residual compressive stress of the center core becomes zero by appropriately adjusting a linear velocity, a tension, and a temperature at the time of drawing of the optical fiber.

FIG. 4 is a schematic view of the refractive index profile of the optical fiber according to the comparative example. In FIG. 4, a profile P31 indicates the refractive index profile of the core portion, and a profile P32 indicates the refractive index profile of the cladding portion 1b. The profile P31a denotes the refractive index profile of the center core, the profile P31b denotes the refractive index profile of the intermediate layer, and the profile P31c denotes the refractive index profile of the trench layer.

In the refractive index profile illustrated in FIG. 4, unlike the refractive index profile illustrated in FIG. 2, in the radial direction, the relative refractive-index difference is non-continuously changed from the center core to the trench layer. In other words, the refractive index profile is sharply bent in the vicinity of the boundary between the intermediate layer and the trench layer, and an amount of change in the refractive index profile is larger than 0.1% per 1 μm in the radial direction.

The properties of the optical fibers according to the comparative example and Examples 1 to 6 are illustrated in Table 1-1 and Table 1-2. An item of a “core compressive stress” indicates the maximum value of the residual compressive stress of the center core. An item of a “clad tensile stress” indicates the maximum value of the residual tensile stress of the cladding portion. An item of “Δ1 before addition of compressive stress” indicates an amount of Δ1 caused by an increase in the refractive index due to Ge. An item of “Δ1 after addition of compressive stress” indicates an amount of Δ1 obtained after the compressive stress is applied by a drawing process performed on the optical fiber. An item of an “increase in Δ1 due to compressive stress” indicates an amount of increase in Δ1 caused by the photoelastic effect due to the compressive stress. An item of “MFD” indicates a value at the wavelength of 1310 nm. An item of a “macrobending loss” indicates a value at the wavelength of 1550 nm, and each of items of “$30” and “$20” indicates the diameter at a time of winding of the optical fiber.

As illustrated in Table 1-1 and Table 1-2, all of Examples 1 to 6 indicate a low bending loss while an increase in the transmission loss being suppressed. In particular, regarding the property of “$20”, all of Examples 1 to 6 satisfy the standard defined by ITU-T G657.Δ2. Specifically, in Example 1, the core compressive stress is 80 MPa, the clad tensile stress is 30 MPa, and Δ1 is increased by 0.09% from 0.33% to 0.42% caused by the compressive stress. In this case, the transmission loss is 0.176 dB/km at the wavelength of 1550 nm, the MFD is 9.02 μm at the wavelength of 1310 nm, the cable cutoff wavelength is 1236 nm, and the zero dispersion wavelength is 1311 nm. Furthermore, the macrobending loss at the wavelength of 1550 nm when the optical fiber is wound with a diameter of 20 mm is 0.048 dB/turn, and the macrobending loss at the wavelength of 1550 nm when the optical fiber is wound with a diameter of 30 mm is 0.014 dB/turn.

TABLE 1-1

| | | | | Δ1 after | increase |
|---|---|---|---|---|---|
| | core | | Δ1 before | addition of | in Δ1 |
| | compres- | clad | addition of | compres- | due to |
| | sive | tensile | compres- | sive | compres- |
| | stress | stress | sive | stress | sive |
| Example | [MPa] | [MPa] | stress [%] | [%] | stress [%] |
| Comparative | 0 | 5 | 0.33 | — | — |
| Example | | | | | |
| Example 1 | 80 | 30 | 0.33 | 0.42 | 0.09 |
| Example 2 | 50 | 22 | 0.46 | 0.54 | 0.08 |
| Example 3 | 90 | 22 | 0.40 | 0.50 | 0.10 |
| Example 4 | 50 | 20 | 0.36 | 0.38 | 0.02 |
| Example 5 | 150 | 50 | 0.36 | 0.46 | 0.10 |
| Example 6 | 40 | 15 | 0.40 | 0.46 | 0.06 |

TABLE 1-2

| | | transmission loss | | | | | macrobending loss | |
|---|---|---|---|---|---|---|---|---|
| | | [dB/km] | | | | | [dB/turn] | |
| | −Δmax | @1.31 | @1.55 | MFD | λcc | λ0 | φ30 | φ20 |
| Example | [%] | [μm] | [μm] | [μm] | [nm] | [nm] | [nm] | [nm] |
| Comparative | −0.27 | 0.331 | 0.187 | 9.37 | 1170 | 1307 | 0.551 | 1.506 |
| Example | | | | | | | | |
| Example 1 | −0.18 | 0.326 | 0.176 | 9.02 | 1236 | 1311 | 0.014 | 0.048 |
| Example 2 | −0.13 | 0.331 | 0.188 | 8.261 | 1267 | 1310 | 0.001 | 0.001 |
| Example 3 | −0.16 | 0.332 | 0.186 | 8.312 | 1270 | 1310 | 0.002 | 0.005 |
| Example 4 | −0.22 | 0.341 | 0.192 | 9.13 | 1238 | 1306 | 0.15 | 0.058 |
| Example 5 | −0.14 | 0.348 | 0.194 | 8.95 | 1372 | 1305 | 0.001 | 0.004 |
| Example 6 | −0.2 | 0.330 | 0.186 | 8.399 | 1189 | 1309 | 0.006 | 0.014 |

As described above, the optical fiber according to the present disclosure is suitable for implementation of an optical fiber having a low bending loss while an increase in a transmission loss being suppressed.

According to the present disclosure, an advantage is provided in that it is possible to implement an optical fiber that has a low bending loss while an increase in a transmission loss being suppressed.

Furthermore, the present disclosure is not limited to the embodiment described above. The present disclosure also includes those formed by combining components of the embodiments as appropriate. In addition, further effects and modifications will readily occur to those skilled in the art. Therefore, wider aspects of the present disclosure are not limited to the embodiments described above, and various modifications may be made.

What is claimed is:

1. An optical fiber comprising:
a core portion; and
a cladding portion that has a refractive index lower than a maximum refractive index of the core portion and that surrounds an outer periphery of the core portion, wherein
the core portion includes
a center core doped with germanium, and
a low refractive index layer that surrounds an outer periphery of the center core, and in which −Δmax that is a minimum value of a relative refractive-index difference with respect to an average refractive index of the cladding portion is a negative value,
a residual compressive stress in the center core is equal to or larger than 40 MPa and equal to or less than 150 MPa, and
Δ1 that is an average maximum relative refractive-index difference of the center core with respect to the average refractive index of the cladding portion is equal to or less than 0.8%.

2. The optical fiber according to claim 1, wherein the −Δmax is equal to or larger than −0.5% and equal to or less than −0.1%.

3. The optical fiber according to claim 1, wherein the low refractive index layer is a trench layer that is separated from the center core.

4. The optical fiber according to claim 3, wherein
a diameter of the center core is equal to or larger than 3 μm and equal to or less than 8 μm, and
an outer diameter of the trench layer is equal to or larger than 9 μm and equal to or less than 20 μm.

5. The optical fiber according to claim 4, wherein
the diameter of the center core is equal to or larger than 3.5 μm and equal to or less than 7.5 μm, and
the outer diameter of the trench layer is equal to or larger than 9.5 μm and equal to or less than 19 μm.

6. The optical fiber according to claim 5, wherein
the diameter of the center core is equal to or larger than 3.5 μm and equal to or less than 5 μm, and
the outer diameter of the trench layer is equal to or larger than 12 μm and equal to or less than 16 μm.

7. The optical fiber according to claim 1, wherein the low refractive index layer is a depressed layer that is adjacent to the center core.

8. The optical fiber according to claim 7, wherein
a diameter of the center core is equal to or larger than 3 μm and equal to or less than 8 μm, and
an outer diameter of the depressed layer is equal to or larger than 9 μm and equal to or less than 20 μm.

9. The optical fiber according to claim 8, wherein
the diameter of the center core is equal to or larger than 3.5 μm and equal to or less than 7.5 μm, and
the outer diameter of the depressed layer is equal to or larger than 9.5 μm and equal to or less than 19 μm.

10. The optical fiber according to claim 9, wherein
the diameter of the center core is equal to or larger than 3.5 μm and equal to or less than 5 μm, and
the outer diameter of the depressed layer is equal to or larger than 12 μm and equal to or less than 16 μm.

11. The optical fiber according to claim 1, wherein the relative refractive-index difference is continuously changed from the center core to the low refractive index layer in a radial direction.

12. The optical fiber according to claim 11, wherein the relative refractive-index difference being continuously changed implies that a refractive index profile representing the relative refractive-index difference is not sharply bent but is smoothly changed, and implies that an amount of change in the relative refractive-index difference is equal to or less than 0.1% per 1 μm in the radial direction.

13. The optical fiber according to claim 1, wherein a residual compressive stress in the low refractive index layer is equal to or larger than 20 MPa and equal to or less than 200 MPa.

14. The optical fiber according to claim 1, wherein the low refractive index layer includes fluorine.

15. The optical fiber according to claim 1, wherein
a transmission loss at a wavelength of 1550 nm is equal to or less than 0.190 dB/km,
a mode field diameter at a wavelength of 1310 nm is equal to or larger than 8.6 μm,
a cable cutoff wavelength is equal to or less than 1260 nm, and
a zero dispersion wavelength is equal to or larger than 1300 nm.

16. The optical fiber according to claim 1, wherein a macrobending loss at a wavelength of 1550 nm when the optical fiber is wound with a diameter of 20 mm is equal to or less than 0.1 dB/turn.

17. The optical fiber according to claim 1, wherein a cladding diameter is within a range of 75 μm to 135 μm.

18. The optical fiber according to claim 1, further comprising
a coating portion that includes
a primary layer that surrounds an outer periphery of the cladding portion, and
a secondary layer that surround an outer periphery of the primary layer, wherein
an outer diameter of the secondary layer is equal to or less than 260 μm,
the primary layer is made of resin in which Young's modulus is equal to or larger than 0.2 MPa and equal to or less than 3 MPa, and
the secondary layer is made of resin in which Young's modulus is equal to or larger than 5 MPa and equal to or less than 2000 MPa.

19. The optical fiber according to claim 1, wherein a maximum value of a difference of a residual stress between the core portion and the cladding portion is equal to or larger than 40 MPa and equal to or less than 220 MPa.

20. The optical fiber according to claim 1, wherein a maximum value of a difference of a residual stress between the core portion and the cladding portion is equal to or larger than 70 MPa and equal to or less than 220 MPa.
